(19) United States
(12) Patent Application Publication
(10) Pub. No.: US 2018/0206153 A1
(43) Pub. Date: Jul. 19, 2018

(54) AUTHENTICATION METHOD AND APPARATUS FOR HANDOVER IN INTERWORKING OF LONG TERM EVOLUTION AND WI-FI

(71) Applicant: MediaTek Singapore Pte. Ltd., Singapore (SG)

(72) Inventors: Wenze Qu, Beijing (CN); Pi-Yuan Cheng, Kaohsiung City (TW); Yuhhua Hu, Hsinchu County (TW)

(21) Appl. No.: 15/615,838

(22) Filed: Jun. 7, 2017

(30) Foreign Application Priority Data
Jan. 13, 2017 (CN) 201710024233.9

(51) Int. Cl. H04W 36/00; H04J 11/00; H04W 36/30; H04W 16/32; H04W 36/20

(52) U.S. Cl. CPC H04W 36/0022; H04J 11/0026; H04W 36/0066; H04M 2215/32; H04W 16/32; H04W 36/20; H04W 36/30

(57) ABSTRACT

The present invention provides methods and apparatus for reducing Wi-Fi authentication process time in interworking of Long Term Evolution (LTE) and Wi-Fi. The method comprises: activating a Wi-Fi authentication process; monitoring a Wi-Fi signal quality; determining whether to stop the Wi-Fi authentication process according to the Wi-Fi signal quality; and stopping the Wi-Fi authentication process when the Wi-Fi signal quality does not satisfy a first specific condition. The UE comprises: a processing circuit, having functions of: activating a Wi-Fi authentication process; monitoring a Wi-Fi signal quality; determining whether to stop the Wi-Fi authentication process according to the Wi-Fi signal quality; and stopping the Wi-Fi authentication process when the Wi-Fi signal quality does not satisfy a first specific condition.

### BACKGROUND

The present invention relates to a communication device and an operating method thereof, and more particularly, to an authentication method for a communication device performing network handover in a cellular network radio access technology (RAT) and wireless local area network (WLAN) technology interworking.

With the rapid development of wireless communication technology, communication devices can simultaneously support a variety of cellular network radio access technology (For example, 3GPP compliant 3G WCDMA/TD-SCDMA/CDMA2000 technology, 4G LTE technology, etc.) and WLAN technology (for example, Wi-Fi technology, wherein Wi-Fi is also known as wireless fidelity technology). The further development has led to the presence of communication devices handover between a variety of cellular network radio access technologies (e.g., LTE technology) and the WLAN technology (such as Wi-Fi).

Take the handover between LTE and Wi-Fi as an example. Please refer to FIG. 1, which shows a diagram of a transition between the services of the voice over Wi-Fi (VoWiFi) and the voice over LTE (VoLTE) for a user equipment (UE) 102, wherein the dotted lines represent signaling transmission paths for control signal transmission, and the solid lines represent data transmission paths for data transmission (such as voices, images, etc.). As shown in FIG. 1, when the UE 102 uses the LTE communication mode (i.e. VoLTE), the UE 102 can be connected via a cellular radio access network 104 to a public data network (PDN) gateway (PGW) 106, and further establish a connection to the IP Multimedia Subsystem (IMS) 108 via the PGW 106, so that the cellular network provides the IMS service (such as VoLTE) for the UE 102. The UE 102 camps on a cell (including macrocell, micro cell, picocell, femtocell, etc.) provided by a base station (BS) (e.g., node B (NB), Enhanced node B (eNB), etc.) in the cellular radio access network 104. To establish an IMS service connection, the UE 102 can communicate via the cellular radio access network 104, the PGW 106, and a policy and charging rules function (PCRF) module 114 provided by operators to send a request signal to the IMS 108. In addition, the UE 102 can also use Wi-Fi to provide IMS services (such as VoWiFi) for users. After the UE 102 completes the transition to the Wi-Fi communication mode, the UE 102 can establish an IP security tunnel (IPsec tunnel) between an evolved packet data gateway (ePDG) 112 via a Wi-Fi access point (AP) 110 and further connect to the IMS 108 through the PGW 106. Before transitioning to use the LTE communication mode, the UE 102 will firstly transmit a request signal to the IMS 108 through the Wi-Fi AP 110, the ePDG 112, the PGW 106, an authentication authorization account (AAA) server 116 and a home subscriber server (HSS) 118 to perform a plurality of stages (also referred to as phases) of the authentication process.

At present, the UE has to complete the entire authentication process to determine whether to handover from the cellular network (for example, VoLTE) to a wireless local area network (for example, VoWiFi), and this process in theory usually takes 1 to 2 seconds. If the network quality is poor, the process may even take longer (for example, 5 to 10 seconds). However, during this time, the signal quality of wireless access technologies (such as LTE) and WLAN technologies (such as Wi-Fi) is likely to change, and no longer suitable for handover. Therefore, for the handover authentication process in the cellular network and WLAN interworking, it will result in a waste of time and resources.

### SUMMARY

According to a first aspect of the present invention, an exemplary authentication method implemented by a user equipment for handover from a cellular network radio access technology (RAT) to a wireless local area network (WLAN) technology is disclosed. The exemplary network handover authentication method comprises: activating a WLAN technology authentication process; monitoring a WLAN technology signal quality; determining whether to stop the WLAN technology authentication process according to the WLAN technology signal quality; and stopping the WLAN technology authentication process when the WLAN technology signal quality is not suitable for performing the handover process.

According to a second aspect of the present invention, an exemplary authentication method implemented by a user equipment for handover from a cellular network radio access technology (RAT) to a wireless local area network (WLAN) technology is disclosed. The exemplary network handover authentication method comprises: activating a WLAN technology authentication process; monitoring a cellular network RAT signal quality; determining whether to stop the WLAN technology authentication process according to the cellular network RAT signal quality; and stopping the WLAN technology authentication process when the cellular network RAT signal quality is not suitable for performing the handover process.

According to a third aspect of the present invention, an exemplary authentication method implemented by a network side device for a user equipment handover from a cellular network radio access technology (RAT) to a wireless local area network (WLAN) technology is disclosed. The exemplary network handover authentication method comprises: receiving a first authentication request signal for the WLAN technology from the user equipment; Starting a timer to calculate a specific time period after transmitting a response signal corresponding to the first authentication request signal; determining whether a second authentication request signal is received from the user equipment within the specific time period; and stopping the WLAN technology authentication process when there is no second authentication request signal within the specific time period.

In view of the above, one of the advantages of the present invention is that the wireless LAN (such as Wi-Fi) authentication process for handover can be stopped when the wireless local area network (Such as Wi-Fi) signal quality is not good in the network handover process of a cellular radio access technology (such as LTE) and wireless LAN technology (such as Wi-Fi) interworking, without waiting for the completion of the entire authentication operation, thereby reducing the waste of time and resources, and avoid the mobile communication device from being handed over to a wireless LAN (such as Wi-Fi) AP with poor signal quality.

### BRIEF DESCRIPTION OF THE DRAWINGS

These and other objectives of the present invention will no doubt become obvious to those of ordinary skill in the art after reading the following detailed description of the preferred embodiment that is illustrated in the various figures and drawings.

FIG. 1 shows a diagram of a transition between the services of the voice over Wi-Fi (VoWiFi) and the voice over LTE (VoLTE) for a user equipment (UE).

FIG. 2 is a simplified diagram of a mobile communication device (also referred to as a user equipment (UE)) according to an embodiment of the present invention.

FIG. 3 is a flowchart showing a Wi-Fi authentication procedure in accordance with an embodiment of the present invention.

FIG. 4 is a flow chart of an authentication method of a mobile communication device handover from the LTE to the Wi-Fi in the LTE and Wi-Fi interworking according to an embodiment of the present invention.

FIG. 5 is a flow chart of an authentication method of a mobile communication device handover from the LTE to the Wi-Fi in the LTE and Wi-Fi interworking according to an embodiment of the present invention.

FIG. 6 is a flow chart of an authentication method of a mobile communication device handover from the LTE to the Wi-Fi in the LTE and Wi-Fi interworking according to an embodiment of the present invention.

FIG. 7 is a flow chart of an authentication method of a network side device handover from the LTE to the Wi-Fi in the LTE and Wi-Fi interworking according to an embodiment of the present invention.

### DETAILED DESCRIPTION

Certain terms are used throughout the description and following claims to refer to particular components. As one skilled in the art will appreciate, manufacturers can refer to a component by different names. This document does not intend to distinguish between components that differ in name but not function. In the following description and in the claims, the terms “comprise” and “comprise” are used in an open-ended fashion, and thus should be interpreted to mean “comprise, but not limited to . . . ”. Also, the term “couple” is intended to mean either an indirect or direct electrical connection. Accordingly, if one device is coupled to another device, that connection can be via a direct electrical connection, or via an indirect electrical connection via other devices and connections.

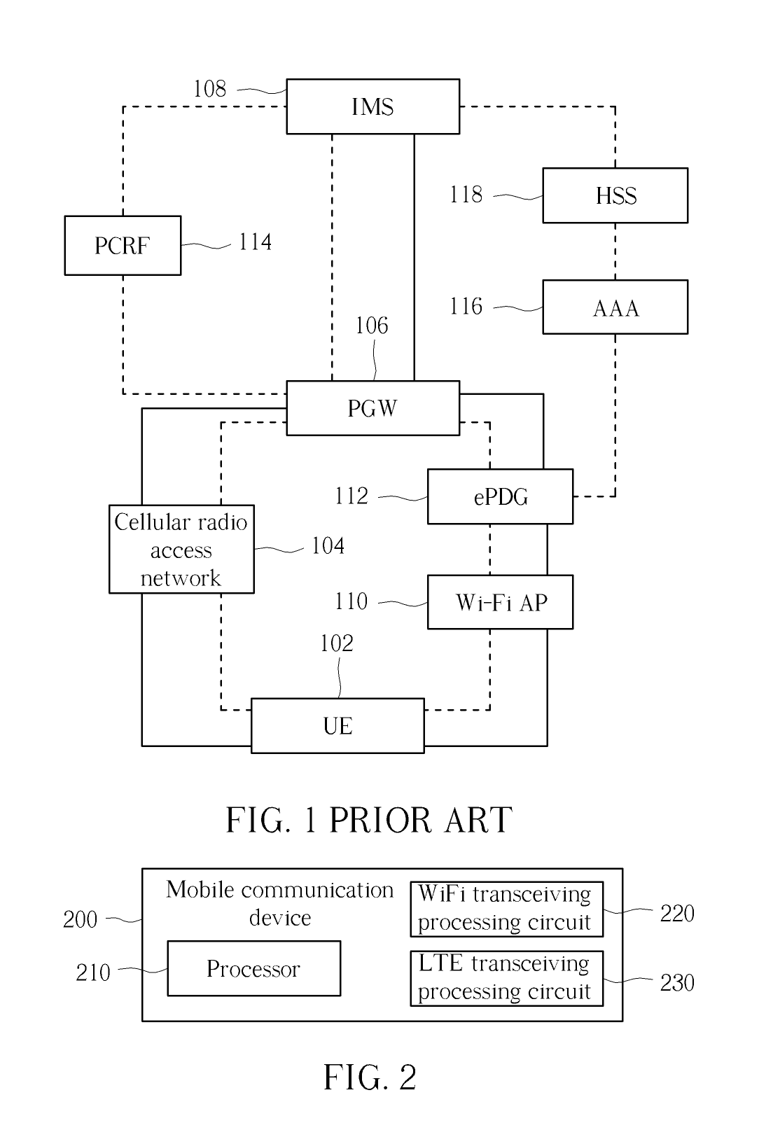

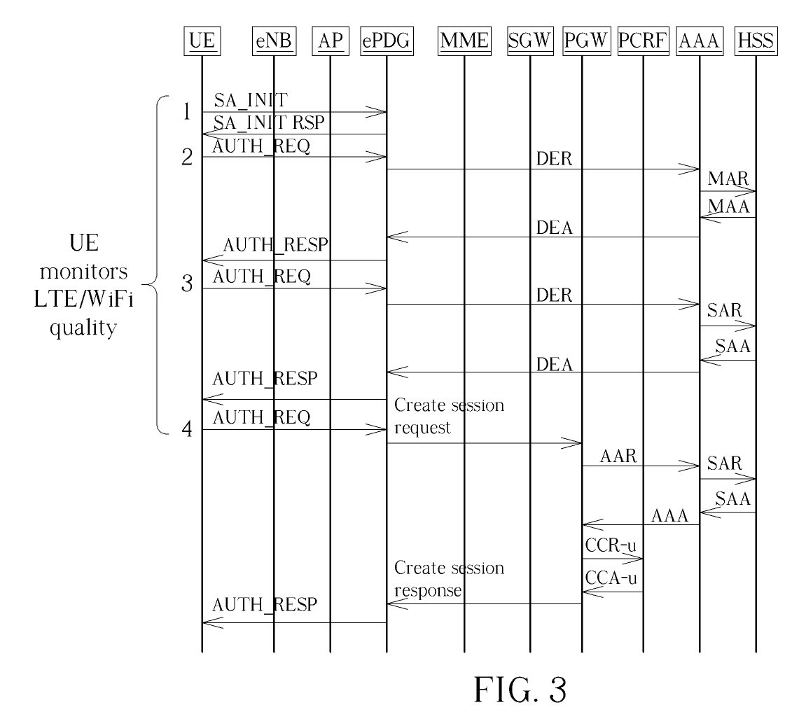

Please refer to FIG. 2, which is a simplified diagram of a mobile communication device (also referred to as a user equipment (UE)) 200 according to an embodiment of the present invention. The mobile communication device 200 can be adapted for interworking between cellular network radio access technologies (such as LTE) and wireless local area network (WLAN) technologies (such as Wi-Fi), wherein the mobile communication device 200 is an example of the UE 102 shown in FIG. 1. For example, the mobile communication device 200 can be an electronic device such as a smart phone, a personal digital assistant, a notebook computer, and the present invention is not limited thereto. As shown in FIG. 2, the mobile communication device 200 comprises, but is not limited to, a processor 210, a WiFi transceiving processing circuit 220, and an LTE transceiving processing circuit 230, wherein the WiFi transceiving processing circuit 220 and the LTE transceiving processing circuit 230 are coupled to the processor 210, respectively. The LTE transceiver processing circuit 230 comprises a plurality of hardware elements utilized for the radio frequency (RF) signal processing and the baseband (BB) signal processing. The LTE transceiver processing circuit 230 can receive a RF signal from the LTE network via an antenna and convert the received RF signal into a BB signal, and perform a further processing under control of the processor 210 after performing a series of signal processing (such as analog-to-digital conversion (ADC), decoding, demodulation, etc.) for the BB signal. Or, The LTE transceiver processing circuit 230 can also convert the BB signal processed by a reverse signal processing (such as modulation, encoding, digital-to-analog conversion (DAC), etc.) to the RF signal according to the instructions of the processor 210, and transmit the RF signal to the LTE network via the antenna. The WiFi transceiver processing circuit 220 also comprises a plurality of hardware elements utilized for the RF signal processing and the BB signal processing, and utilized for performing signal transceiving and processing (including the RF signal processing and the BB signal processing, etc.) between the wireless local area network under the control of the processor 210.

The processor 210 can be a general purpose processor, a microprocessor unit (MPU), a micro control unit (MCU), an application processor (AP), a specific integrated circuit (SPIC), or a digital signal processor (DSP), and the present invention is not limited thereto. Please note that although the WiFi transceiving processing circuit 220 and the LTE transceiving processing circuit 230 in FIG. 2 are shown as independent circuit modules, the signal processing path(s) for performing RF processing and BB processing on the signals can be shared between the WiFi transceiving processing circuit 220 and the LTE transceiving processing circuit 230, and the present invention is not limited to this. In addition, the processor 210, the WiFi transceiver processing circuit 220, and the LTE transceiver processing circuit 230 can be independent circuits. However, depending on the actual design requirements, the processor 210 also can be integrated with at least a part or all of the WiFi transceiving processing circuit 220 and the LTE transceiving processing circuit 230, and the present invention is not limited to this.

Please note that the mobile communication device 200 shown in FIG. 2 is merely an illustration, and the WiFi transceiving processing circuit 220 can be a transceiving processing circuit of other wireless LAN technologies, and the LTE transceiving processing circuit 230 also can be a transceiving processing circuit of other cellular network radio access technologies (Such as WCDMA, TD-SCDMA, CDMA2000, etc.), and the present invention is not limited thereto.

Please refer to FIG. 3, which is a flowchart showing a Wi-Fi authentication procedure in accordance with an embodiment of the present invention, wherein the element abbreviations in FIG. 3 can be referred to in the description of FIG. 1. In this embodiment, the mobile communication device (also referred to as UE) is ready to perform handover from the LTE to the Wi-Fi to implement the transition from the VoLTE to the VoWiFi service. As shown in FIG. 3, the Wi-Fi certification process comprises the following four phases:

The first phase: Security association (SA) initialization phase. The UE 102 transmits a SA initialization request signal SA_INIT to the ePDG 112 via the Wi-Fi AP 110, and an SA channel will be established between the UE 102 and the ePDG 112 when the UE 102 receives a SA initialization response signal SA_INIT RSP responded by the ePDG 112, wherein the SA request signal SA_INIT and the SA response signal SA_INIT RSP can be encrypted, for example, by using the IKEv2 encryption method specified in the 3GPP standard. The ePDG 112 starts to set a timer while transmitting the SA response signal SA_INIT RSP.

The second phase: Access request authorization phase. After the channel is established between the UE 102 and the ePDG 112, the UE 102 will transmit an authentication request signal AUTH_REQ to the ePDG 112, and then the ePDG 112 transmits a Diameter EAP Request (DER) signal to the AAA server 116, and then the AAA server 116 transmits MAR-Multimedia Request (MAR) signal to the HSS 118, and the HSS 118 sends back a MAA multimedia-response (MAA) signal to the AAA server 116, and then the AAA server 116 responses the Diameter EAP Answer (DEA) encryption response signal to the ePDG 112, and then the ePDG 112 responses an authentication response signal AUTH_RESP to the UE 102, wherein the authentication request signal AUTH_REQ and the authentication response signal AUTH_RESP can be encrypted, for example, by using the IKEv2 encryption method specified by the 3GPP standard.

The third phase: Authorization challenge phase. The UE 102 transmits the authentication request signal AUTH_REQ to the ePDG 112, and then the ePDG 112 transmits the DER information to the AAA server 116, and then the AAA server 116 transmits a server assignment request (SAR) signal SAR to the HSS 118, and then the HSS 118 responses the SAA server assignment answer (SAA) to the AAA server 116, and then the AAA server 116 responses the DEA response information to the ePDG 112, and then the ePDG 112 responses the authentication response signal AUTH_RESP to the UE 102, wherein the authentication request signal AUTH_REQ and the authentication response signal AUTH_RESP can be encrypted, for example, by using the IKEv2 encryption method specified by the 3GPP standard.

The fourth phase: Session Creation phase. UE 102 transmits an authentication request signal AUTH_REQ to the ePDG 112, and then the ePDG 112 transmits a create session request signal to PGW 106, and then PGW 106 transmits an authentication authorization request (AAR) signal AAR to the AAA server 116, and then the AAA server 116 transmits the SAR server assignment request signal to the HSS 118, and the HSS 118 responses an SAA server assignment reply signal to the AAA server 116, and then the AAA server 116 sends back an authentication authorization answer (AAA) signal to the PGW 106, and then the PGW 106 transmits a credit control request (CCR)-u signal to the PCRF module 114, and then the PCRF module 114 responses a credit control answer (CCA)-u trust control response signal to the PGW 106, and then the PGW 106 responses a create session response signal to the ePDG 112, and then the ePDG 112 responses the authentication response signal AUTH_RESP to the UE 102, wherein the authentication request signal AUTH_REQ and the authentication response signal AUTH_RESP can be encrypted, for example, by using the IKEv2 encryption method specified by the 3GPP standard.

According to various embodiments of the present invention, the UE keeps monitoring the Wi-Fi signal quality and/or the LTE signal quality during the WiFi authentication process described above, and once the UE determines that the monitored Wi-Fi and/or the monitored LTE signal quality is no longer suitable for handover, the UE will stop the current Wi-Fi authentication operation (for example, the UE stops sending the authentication request signal to the ePDG at any one of the four phases described in FIG. 3) without completing the entire authentication process. According to various embodiments of the present invention, the present invention can be implemented or carried out at any phase of the four phases of the above-described network handover authentication operation. In other words, once the monitored Wi-Fi and/or the monitored LTE signal quality is determined no longer suitable for handover, the mobile communication device according to the various embodiments of the present invention can stop the Wi-Fi authentication process at any time during the handover process from a cellular network radio access technology (such as the LTE) to a wireless local area network technology (such as the Wi-Fi).

According to some embodiments of the present invention, the parameters used to measure the quality of the Wi-Fi signal can be a received signal strength indication (RSSI), a signal to noise ratio (SNR), a transmit/receive (Tx/Rx) data rate, a packet error rate, and/or a packet loss rate under Real Time Transport Control Protocol (RTCP). The parameters used to measure the quality of the LTE signal can be a reference signal reception power (RSRP), a reference signal reception quality (RSRQ), a signal to noise ratio (SNR), a signal to interference ratio (SIR), and/or a packet loss rate. Please note that the above-described embodiments are merely for an illustrative purpose and is not meant to be a limitation of the present invention.

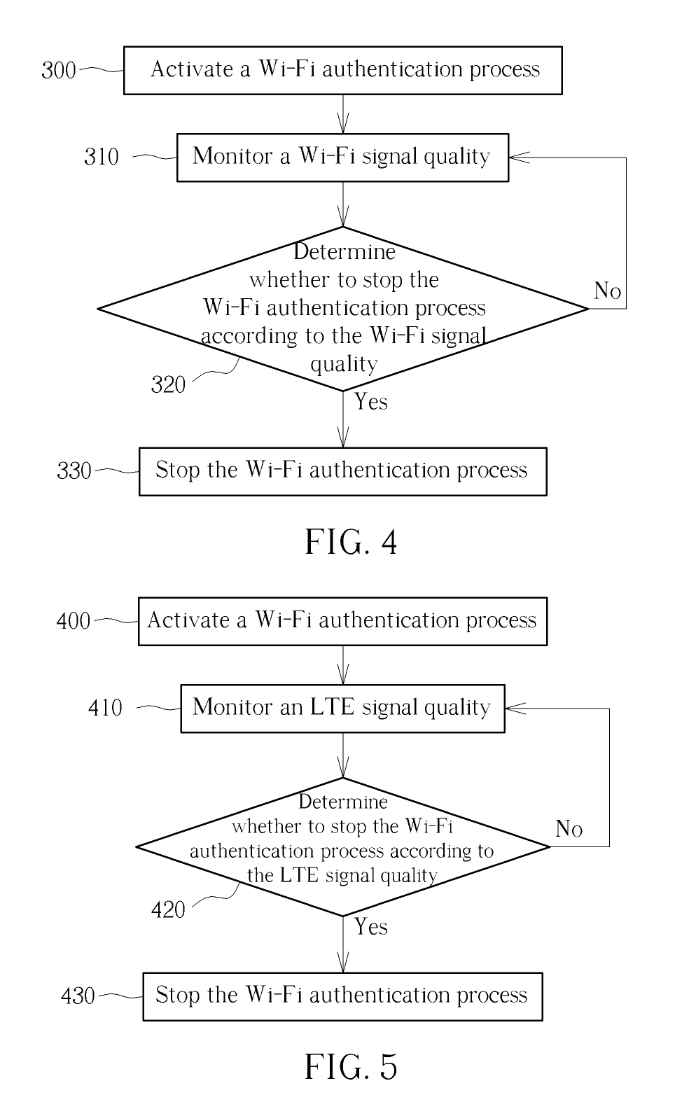

Please refer to FIG. 4, which is a flow chart of an authentication method of a mobile communication device handover from the LTE to the Wi-Fi in the LTE and Wi-Fi interworking according to an embodiment of the present invention, and if the same result can be obtained substantially, the steps in the process do not necessarily need to be performed in the order shown in FIG. 4, nor do they necessarily need to be contiguous, that is, these steps can be inserted between the other steps, and these steps can also be split or combined, and the present invention is not limited thereto. The authentication method in the present embodiment can be performed by a processing circuit in the mobile communication device. As shown in FIG. 4, the authentication method in this embodiment comprises the following steps:

Step 300: Activate a Wi-Fi authentication process.

Step 310: Monitor a Wi-Fi signal quality.

Step 320: Determine whether to stop the Wi-Fi authentication process according to the Wi-Fi signal quality.

According to some embodiments of the present invention, the UE can determine whether the monitored Wi-Fi signal quality satisfies a specific condition, for example, by comparing the monitored one or more parameters associated with the Wi-Fi signal quality with a threshold to determine whether the current Wi-Fi signal quality is suitable for handover. If the UE determines that the monitored Wi-Fi signal quality is suitable to continue the handover, for example, the monitored Wi-Fi signal quality is better than or equal to the threshold level, and can meet with the requirements for normal operation of IMS service after the UE is handed over to a Wi-Fi network such as the VoWiFi, then the Wi-Fi authentication process is determined not to be stopped, and go back to the Step 310 to keep on monitoring the Wi-Fi signal quality; and if the UE determines that the monitored Wi-Fi signal quality is no longer suitable for continuing the handover (e.g., the monitored Wi-Fi signal quality is below the threshold level, and cannot meet with the requirements for normal operation of IMS service after the UE is handed over to a Wi-Fi network such as the VoWiFi), then the Wi-Fi authentication process is determined to be stopped, and go to the Step 330.

Step 330: Stop the Wi-Fi authentication process.

According to some embodiments of the present invention, the UE can stop the current Wi-Fi authentication process by stopping the process of sending a corresponding authentication request signal to the network side in the current phase of the handover authentication process.

Please refer to FIG. 5, which is a flow chart of an authentication method of a mobile communication device handover from the LTE to the Wi-Fi in the LTE and Wi-Fi interworking according to an embodiment of the present invention, and if the same result can be obtained substantially, the steps in the process do not necessarily need to be performed in the order shown in FIG. 5, nor do they necessarily need to be contiguous, that is, these steps can be inserted between the other steps, and these steps can also be split or combined, and the present invention is not limited thereto. The authentication method in the present embodiment can be performed by a processing circuit in the mobile communication device. As shown in FIG. 5, the authentication method in this embodiment comprises the following steps:

Step 400: Activate a Wi-Fi authentication process.

Step 410: Monitor an LTE signal quality.

Step 420: Determine whether to stop the Wi-Fi authentication process according to the LTE signal quality.

According to some embodiments of the present invention, the UE can determine whether the monitored LTE signal quality satisfies a specific condition, for example, by comparing the monitored one or more parameters associated with the LTE signal quality with a threshold to determine whether the current LTE signal quality is suitable for handover. If the UE determines that the monitored LTE signal quality is suitable to continue the handover, for example, the monitored LTE signal quality is better than or equal to the threshold level, and can meet with the requirement for normal operation of IMS service after the UE is handed over to an LTE network such as the VoLTE, then the Wi-Fi authentication process is determined not to be stopped, and go back to the Step 410 to keep on monitoring the LTE signal quality; and if the UE determines that the monitored LTE signal quality is no longer suitable for continuing the handover (e.g., the monitored LTE signal quality is below the threshold level, and cannot meet with the requirements for normal operation of IMS service after the UE is handed over to an LTE network such as the VoLTE), then the Wi-Fi authentication process is determined to be stopped, and go to the Step 430.

Step 430: Stop the Wi-Fi authentication process.

According to some embodiments of the present invention, the UE can stop the current LTE authentication process by stopping the process of sending a corresponding authentication request signal to the network side in the current phase of the handover authentication process.

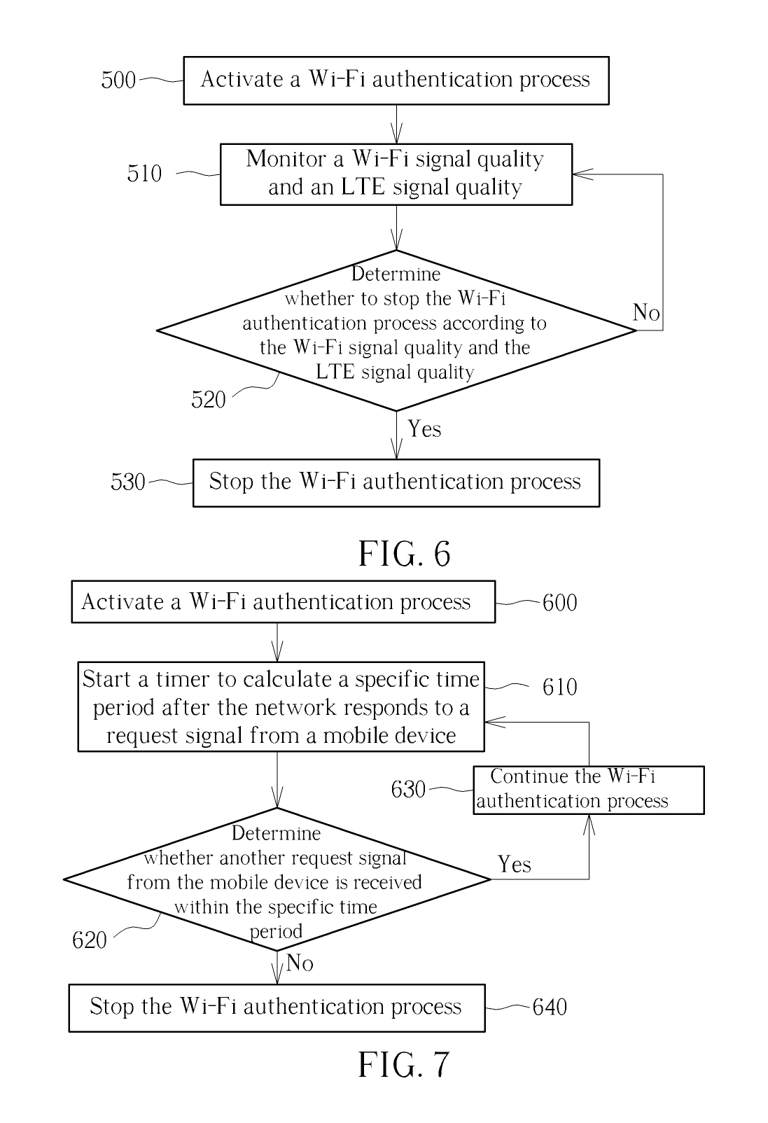

Please refer to FIG. 6, which is a flow chart of an authentication method of a mobile communication device handover from the LTE to the Wi-Fi in the LTE and Wi-Fi interworking according to an embodiment of the present invention, and if the same result can be obtained substantially, the steps in the process do not necessarily need to be performed in the order shown in FIG. 6, nor do they necessarily need to be contiguous, that is, these steps can be inserted between the other steps, and these steps can also be split or combined, and the present invention is not limited thereto. The authentication method in the present embodiment can be performed by a processing circuit in the mobile communication device. As shown in FIG. 6, the authentication method in this embodiment comprises the following steps:

Step 500: Activate a Wi-Fi authentication process.

Step 510: Monitor a Wi-Fi signal quality and an LTE signal quality.

Step 520: Determine whether to stop the Wi-Fi authentication process according to the Wi-Fi signal quality and the LTE signal quality.

According to some embodiments of the present invention, the UE can determine whether the monitored Wi-Fi signal quality and the monitored LTE signal quality satisfies a specific condition. If the UE determines that the monitored Wi-Fi signal quality and the monitored LTE signal quality are suitable to continue the handover, then the Wi-Fi authentication process is determined not to be stopped, and go back to the Step 510 to continue monitoring the LTE signal quality; and if the UE determines that the monitored LTE signal quality is no longer suitable for continuing the handover, then the Wi-Fi authentication process is determined to be stopped, and go to the Step 530.

In various embodiments of the present invention, the specific condition can be whether the Wi-Fi signal quality is better than the LTE signal quality. According to a first embodiment of the present invention, the UE can compare a monitored first parameter associated with the Wi-Fi signal quality and a monitored second parameter associated with the LTE signal quality, and if the comparison result shows that the Wi-Fi signal quality is better than the LTE signal quality and suitable for the continuation of the handover, then the UE determines that the specific condition is satisfied. If the comparison result shows that the Wi-Fi signal quality is not better than the LTE signal quality and is no longer suitable for the continuation of the handover, then the UE determines that the specific condition is not satisfied. According to the second embodiment of the present invention, the UE can determine whether the monitored Wi-Fi signal quality meets a first condition (e.g., comparing one or more first parameters associated with the Wi-Fi signal quality with a first threshold level, and if the comparison result shows that the monitored Wi-Fi signal quality is better than or equal to the first threshold level, then the Wi-Fi signal quality satisfies the first condition; otherwise, the first condition is not satisfied), and whether the monitored LTE signal quality satisfies a second condition (for example, comparing one or more second parameters associated with the LTE signal quality with a second threshold level, and if the comparison results show that the monitored LTE signal quality is better than or equal to the second threshold level, then the LTE signal quality satisfies the second condition; otherwise, the second condition is not satisfied). When the UE determines that the Wi-Fi signal quality satisfies the first condition and/or the LTE signal quality does not satisfy the second condition, it means that the Wi-Fi signal quality is better than the LTE signal quality and is suitable for continuing the handover from the LTE to the Wi-Fi. If the UE determines that the Wi-Fi signal quality does not satisfy the first condition and/or the LTE signal quality satisfies the second condition, it means that the Wi-Fi signal quality is not better than the LTE signal quality, and is not suitable for continuing the handover from the LTE to the Wi-Fi, so that the UE determines that the specific condition is satisfied.

Step 530: Stop the Wi-Fi authentication process.

Please refer to FIG. 7, which is a flow chart of an authentication method of a network side device handover from the LTE to the Wi-Fi in the LTE and Wi-Fi interworking according to an embodiment of the present invention, and if the same result can be obtained substantially, the steps in the process do not necessarily need to be performed in the order shown in FIG. 7, nor do they necessarily need to be contiguous, that is, these steps can be inserted between the other steps, and these steps can also be split or combined, and the present invention is not limited thereto. The authentication method in the present embodiment can be performed by a processing circuit in a network side device. As shown in FIG. 7, the authentication method in this embodiment comprises the following steps:

Step 600: Activate a Wi-Fi authentication process. The network side device receives a authentication request signal transmitted by the Mobile Station (MS) (or referred to as UE) to activate the Wi-Fi authentication process.

Step 610: Start a timer to calculate a specific time period after the network responds to a request signal from a mobile device.

Step 620: Determine whether another request signal from the mobile device is received within the specific time period. If there is another request signal received from the mobile device within the specific time period, then go to the Step 630; if there is no other request signal received from the mobile device within the specific time period, then go to the Step 640.

Step 630: Continue the Wi-Fi authentication process.

Step 640: Stop the Wi-Fi authentication process.

According to a plurality of embodiments of the present invention, since the above-described network handover authentication operation implemented by the network side device of the present invention can be performed at any phase in the four phases of the authentication process, the authentication request signal from the mobile communication device for starting the timer can be any one of the SA initialization request signal SA_INIT of the first phase (the security association initialization phase), the authentication request signal AUTH_REQ of the second phase (access request authorization phase), and the authentication request signal AUTH_REQ of the third phase (authorization challenge phase) of the handover authentication process described above. According to various embodiments of the present invention, the above-described network handover authentication method applicable to the network side device can be performed by various kinds of network side devices, such as the ePDG 112 or the AAA server 116 shown in FIG. 1 and FIG. 3, and the present invention is not limited thereto.

The above-described embodiments of the present invention can be embodied in various ways. For example, the embodiments can be implemented by using hardware, software, or a combination thereof. It is to be understood that any elements or combination of the elements that can perform the functions described above can be considered as one or more processors that control the above functions. The one or more processors can be implemented in a variety of ways, such as using specific hardware, or using a general hardware that is programmed to perform the functions described above using microcode or software.

In view of the above, one of the advantages of the present invention is that the wireless LAN (such as Wi-Fi) authentication process for handover can be stopped when the wireless local area network (Such as Wi-Fi) signal quality is not good in the network handover process of a cellular radio access technology (such as LTE) and wireless LAN technology (such as Wi-Fi) interworking, without waiting for the completion of the entire authentication operation, thereby reducing the waste of time and resources, and avoid the mobile communication device from being handed over to a wireless LAN (such as Wi-Fi) AP with poor signal quality.

It is to be noted that the above-described various embodiments of the transition from VoLTE to VoWiFi service are merely illustrations of the present invention and not the limitations of the present invention. For example, the present invention can also be applied to other similar cellular networks and wireless LAN technology, such as the LTE-WLAN Interworking (LWI), the LTE-WLAN Aggregation (LWA), the Radio Access Network (RAN) Controlled LTE-WLAN Interworking (RCLWI), the Access Network Discovery and Selection Function (ANDSF), and the Network-Based IP Flow Mobility (NBIFOM) in the UE-initiated mode and so on. Moreover, in addition to the LTE technology, the cellular network radio access technology can also be the wide-band code division multiple access (WCDMA) technology, the time division synchronous code division multiple access (TD-SCDMA) technology, or the code division multiple access 2000 (CDMA2000) technology, the present invention is not limited thereto.

Those skilled in the art will readily observe that numerous modifications and alterations of the device and method can be made while retaining the teachings of the invention. Accordingly, the above disclosure should be construed as limited only by the metes and bounds of the appended claims.

What is claimed is:

1. An authentication method, implemented by a user equipment for handover from a cellular network radio access technology (RAT) to a wireless local area network (WLAN) technology, the network handover authentication method comprising:
activating a WEAN technology authentication process;
monitoring first signal quality of the WEAN technology;
determining whether to stop the WEAN technology authentication process according to the first signal quality; and
stopping the WEAN technology authentication process when the first signal quality is not suitable for performing the handover process.

2. The method of claim 1, further comprising:
monitoring second signal quality of the cellular network RAT;
determining whether to stop the WEAN technology authentication process according to the second signal quality; and
stopping the WEAN technology authentication process when the second signal quality is not suitable for performing the WEAN technology authentication process.

3. The method of claim 1, wherein the first signal quality is indicated by at least one parameter associating with at least one of received signal strength indication (RSSI), signal to noise ratio (SNR), transmit/receive (Tx/Rx) data rate, packet error rate, and packet loss rate.

4. The method of claim 2, wherein the second signal quality is indicated by at least one parameter associating with at least one of reference signal reception power (RSRP), reference signal reception quality (RSRQ), signal to noise ratio (SNR), signal to interference ratio (SIR), and packet loss rate.

5. The method of claim 1, wherein when the first signal quality is lower than a first threshold level, determining the first signal quality is not suitable for performing the handover process.

6. The method of claim 2, wherein when the first signal quality is not better than the second signal quality, determining both of the first signal quality and the second quality are not suitable for performing the handover process.

7. The method of claim 2, wherein when the first signal quality is lower than a first threshold level and/or the second signal quality is better than or equal to a second threshold level, determining both of the first signal quality and the second signal quality are not suitable for performing the handover process.

8. The method of claim 1, wherein the WLAN technology comprises Wi-Fi technology.

9. The method of claim 1, wherein the cellular network RAT comprises Long Term Evolution (LTE) technology, Wideband Code Division Multiple Access (WCDMA) technology, Time Division Synchronization Code 10-multiple access (TD-SCDMA) technology, or Code Division Multiple Access 2000 (CDMA2000) technology.

10. The method of claim 1, wherein the step of stopping the WLAN technology authentication process comprises:
stopping transmitting a first authentication request signal to a network side corresponding to the WLAN technology.

11. The method of claim 10, wherein the first authentication request signal comprises security association initialization request signal SA_INIT of secure connection initialization phase, authentication request signal AUTH_REQ of access request authorization phase, authentication request signal AUTH_REQ of authorization challenge phase, or authentication request signal AUTH_REQ of create session phase.

12. A network handover authentication method, implemented by a user equipment for handover from a cellular network radio access technology (RAT) to a wireless local area network (WLAN) technology, the network handover authentication method comprising:
activating a WLAN technology authentication process;
monitoring a second signal quality of the cellular network RAT;
determining whether to stop the WLAN technology authentication process according to the second signal quality; and
stopping the WLAN technology authentication process when the second signal quality is not suitable for performing the handover process.

13. The method of claim 12, wherein the second signal quality is indicated by at least one parameter associating with at least one of reference signal reception power (RSRP), reference signal reception quality (RSRQ), signal to noise ratio (SNR), signal to interference ratio (SIR), and packet loss rate.

14. The method of claim 12, wherein when the second signal quality is better than or equal to a second threshold level, determining the the second signal quality is not suitable for performing the handover process.

15. The method of claim 12, wherein the WLAN technology comprises Wi-Fi technology.

16. The method of claim 12, wherein the cellular network RAT comprises Long Term Evolution (LTE) technology, Wideband Code Division Multiple Access (WCDMA) technology, Time Division Synchronization Code 10-multiple access (TD-SCDMA) technology, or Code Division Multiple Access 2000 (CDMA2000) technology.

17. The method of claim 12, wherein the step of stopping the WLAN technology authentication process comprises:
stopping transmitting a first authentication request signal to a network side corresponding to the WLAN technology.

18. The method of claim 17, wherein the first authentication request signal comprises security association initialization request signal SA_INIT of secure connection initialization phase, authentication request signal AUTH_REQ of access request authorization phase, authentication request signal AUTH_REQ of authorization challenge phase, or authentication request signal AUTH_REQ of create session phase.

19. An authentication method, implemented by a network side device for a user equipment handover from a cellular network radio access technology (RAT) to a wireless local area network (WLAN) technology, the network handover authentication method comprising:
receiving a first authentication request signal for the WLAN technology from the user equipment;
Starting a timer to calculate a specific time period after transmitting a response signal corresponding to the first authentication request signal;
determining whether a second authentication request signal is received from the user equipment within the specific time period; and
stopping the WLAN technology authentication process when there is no second authentication request signal received within the specific time period.

20. The method of claim 19, wherein the first authentication request signal is security association initialization request signal SA_INIT of secure connection initialization phase, authentication request signal AUTH_REQ of access request authorization phase, or authentication request signal AUTH_REQ of authorization challenge phase.
